(19) United States
(12) Patent Application Publication
(10) Pub. No.: US 2015/0257160 A1
(43) Pub. Date: Sep. 10, 2015

(54) BASE STATION AND RADIO COMMUNICATION METHOD

(71) Applicant: HITACHI, LTD., Tokyo (JP)

(72) Inventors: Hitoshi ISHIDA, Tokyo (JP); Tomonori YAMAMOTO, Tokyo (JP); Satoshi TAMAKI, Tokyo (JP); Hirotake ISHII, Tokyo (JP)

(21) Appl. No.: 14/597,513

(22) Filed: Jan. 15, 2015

(30) Foreign Application Priority Data
Mar. 5, 2014 (JP) 2014-042272

(51) Int. Cl. H04W 72/04

(52) U.S. Cl. CPC H04W 72/0486

(57) ABSTRACT

Even when a downlink radio traffic volume is larger than an uplink radio traffic volume in a radio communication system, but uplink resources are redundant in a related art radio communication system, free uplink resources could not be sufficiently utilized. In a base station having a cellular unit that performs cellular communication with a terminal, and a D2D unit that performs communication with the terminal through a device-to-device communication system, when the downlink radio resources get tight, and the uplink radio resources are redundant, the D2D unit of the base station conducts transmission and reception with the terminal with the use of the uplink radio resources.

### CROSS-REFERENCE TO RELATED APPLICATION

This is application claims the priority of Japanese Patent Application No. 2014-042272 Filed Mar. 5, 2014, which is incorporated herein by reference in its entirety.

### BACKGROUND OF THE INVENTION

1. Field of the Invention

The present invention relates to abase station, a radio communication system, and a radio communication method, and more particularly to a communication method using uplink radio resources.

2. Description of the Related Art

With the spread of smart phones or tablet devices, there has been a concern about an explosive increase in the radio traffic volume. In order to accommodate the increasing radio traffic, there is a need to improve the accommodatable capacity (radio communication capacity) of the radio traffic. The radio communication traffic can be classified into a downlink traffic transmitted from a base station to a terminal, an uplink traffic transmitted from the terminal to the base station. In a voice communication, there is no large difference between an uplink traffic volume and a downlink traffic volume, but in a data communication, there is a large difference between the uplink traffic volume and the downlink traffic volume. In particular, in downloading of moving images, the downlink traffic volume is remarkably larger than the uplink traffic volume. When a mean traffic volume is compared for a given time, the downlink traffic volume is about eight times to ten times as large as the uplink traffic volume.

A system of distinguishing a downlink communication from an uplink communication is roughly classified into two systems. One of the systems is that difference frequencies are used between the downlink communication and the uplink communication. This system is called “frequency division duplex (FDD)”. The other system is that different time slots are used between the downlink communication and the uplink communication. This is called “time division duplex (TDD)”.

Because the related art radio communication system is intended for voice communication having no large difference between the uplink traffic volume and the downlink traffic volume, bandwidths of an uplink link frequency and a downlink frequency are identical with each other in the FDD. In the TDD, a ratio of time slot between the uplink and the downlink can be adjusted. However, at present, the ratio of the time slot is fixedly operated, and in order to deal with the voice communication, the downlink time slot does not become remarkably larger than the uplink time slot (for example, 10 times, etc.). Therefore, in the related art radio communication system, the downlink radio resources have a tendency to get tight, and the uplink radio resources are redundant. A system that deals with an asymmetric traffic of the uplink and the downlink of this type is disclosed in, for example, JP-A-2002-112326.

Incidentally, as a communication method using the uplink radio resources, in recent years, attention has been paid to a D2D communication (device to device communication) which is a device to device communication system. The D2D communication is a technique for performing direct communication between one terminal and another terminal with the use of the uplink radio resources. The D2D communication and a direct communication technique between the respective terminals are disclosed in, for example, JP-A-2011-55221.

### SUMMARY OF THE INVENTION

For example, as illustrated in JP-A-2002-112326, in a related art radio communication system compatible with the asymmetric traffic between the uplink and the downlink, a ratio in the frequency bandwidth between the uplink and the downlink, or a ratio in the time slot therebetween is changed to control the amount of ratio resources according to a traffic volume. However, the above changes in the radio resources affect all of communications in the base stations and the terminals. This suffers from such problems that there is a need to notify all of the terminals of the changes in the radio resources of the uplink and the downlink, and overheads for control are large.

On the other hand, as a communication method using the uplink resources, there is the D2D communication. An example of the D2D communication is illustrated in FIG. 1. In the D2D communication, a terminal 102-1 and a terminal 102-2 communicate with each other, which are located within respective communication areas, under a control from a base station 101 or a network side.

The D2D is one of the techniques that could effectively use the uplink resources, but suffers from a problem illustrated in FIG. 2. For example, when the terminal 102-1 and the terminal 102-2 are terminals of different communication carriers, the terminal 102-1 and the terminal 102-2 have the potential not to support the same frequency carrier. In this case, although the terminal 102-1 and the terminal 102-2 are located within respective communicatable areas, direct communication cannot be performed using the D2D communication. On the other hand, the terminal 102-1 is distant from a terminal 102-3 and a terminal 102-4, and therefore located outside of the area (or coverage) communicatable with each other. In this case, the terminal 102-1 and the terminal 102-3 cannot perform the D2D communication with each other. Further, when a communication partner of the terminal 102-1 is an application server 104, the terminal 102-1 and the application server 104 cannot perform the D2D communication with each other. When the D2D communication cannot be performed by the above causes, the terminal 102-1 needs to perform the communication with another terminal or the application server through a core network 103 or the base station 101 as in a related art radio communication system.

As described above, in the related art radio communication system, because the D2D communication cannot be performed even when the uplink resources are redundant, free uplink resources could not be sufficiently utilized.

The present invention has been made in view of the above viewpoints, and therefore an object of the present invention is to improve an accommodatable radio traffic volume with the effective use of the uplink resources if the downlink resources get tight, and the uplink resources are redundant.

In the invention disclosed in the present application, an outline of a typical configuration will be described in brief below.

There is provided a base station, including: a cellular unit that performs cellular communication with a terminal; a D2D unit that performs communication with the terminals through a device-to-device communication system; and a control unit that determines a usage status of downlink radio resources and a usage status of uplink radio resources, in which if the downlink radio resources get tight, and the uplink radio resources are redundant as a result of the determination, the D2D unit conducts transmission and reception with the terminal with the use of the uplink radio resources.

Also, there is provided a base station, including: a cellular unit that performs cellular communication with a terminal; a D2D unit that performs communication with the terminals through a device-to-device communication system; and a control unit that determines a usage status of uplink radio resources, in which if the uplink radio resources are redundant as a result of the determination, the D2D unit conducts transmission and reception with another base station with the use of the uplink radio resources.

Further, there is provided a radio communication method in a radio communication system having a terminal and a base station, in which the base station performs cellular communication with the terminal, and in which if downlink radio resources get tight, and uplink radio resources are redundant, the base station conducts transmission and reception with the terminal with the use of the uplink radio resources.

According to the present invention, the redundant uplink resources can be effectively used to improve a radio traffic volume that can be accommodated by the system.

Other problems, configurations, and advantages will become apparent from the description of the following embodiments.

### BRIEF DESCRIPTION OF THE DRAWINGS

FIG. 1 is a conceptual diagram of a D2D communication;

FIG. 2 is a diagram illustrating an example of a problem with the D2D communication;

FIG. 3 is a conceptual diagram of a first embodiment according to the present invention;

FIGS. 4A and 4B are diagrams illustrating a usage example of radio resources in an FDD according to the first embodiment of the present invention;

FIGS. 5A and 5B are diagrams illustrating a usage example of radio resources in a TDD according to the first embodiment of the present invention;

FIG. 6 is a diagram illustrating an example of a device configuration of a base station according to this embodiment;

FIG. 7 is a diagram illustrating an example of an operation procedure according to the first embodiment of the present invention;

FIG. 8 is a diagram illustrating an example of a method of allocating D2D radio resources when the D2D communication is not performed;

FIG. 9 is a diagram illustrating an example of a method of allocating the D2D radio resources when the D2D communication is performed;

FIG. 10 is a diagram illustrating an example in which reception timing of a cellular uplink signal overlaps with a timing of D2D transmission;

FIGS. 11A to 11C are diagrams illustrating examples of frequency division of a D2D signal and a cellular signal;

FIG. 12 is a diagram illustrating an example of time division of the D2D signal and an SRS;

FIG. 13 is a conceptual diagram of a second embodiment according to the present invention;

FIG. 14 is a diagram illustrating an example of an operation procedure according to the second embodiment of the present invention;

FIGS. 15A and 15B are diagrams illustrating a usage example of uplink resources according to a third embodiment of the present invention; and

FIG. 16 is a conceptual diagram of a fourth embodiment according to the present invention.

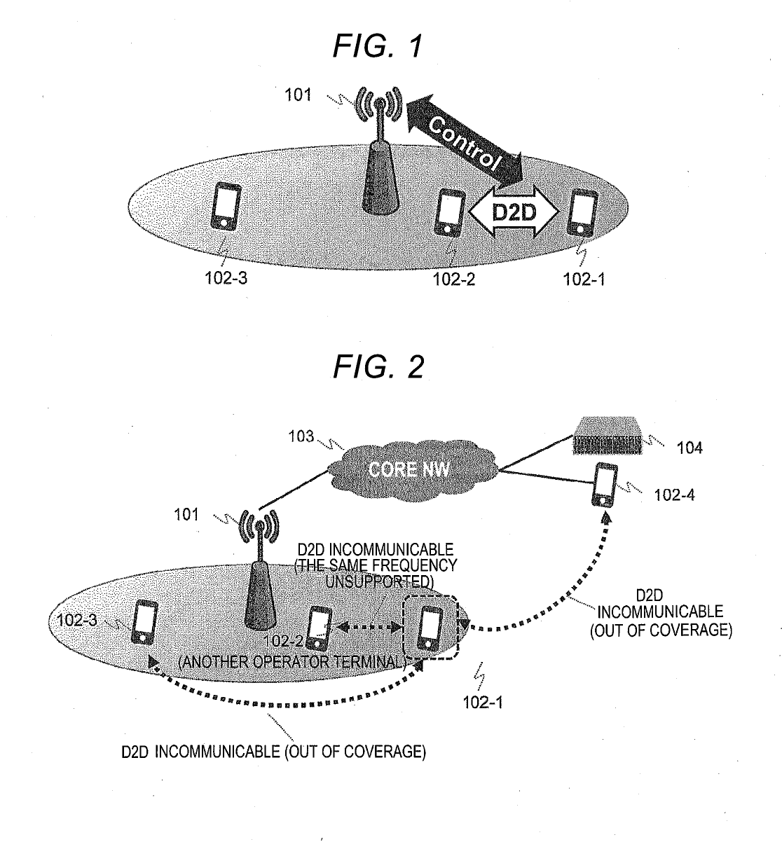

### DETAILED DESCRIPTION OF THE INVENTION

Hereinafter, embodiments of the present invention will be described with reference to the accompanying drawings.

The following embodiments are divided into a plurality of sections and embodiments, when necessary for the sake of convenience. Therefore, unless clearly indicated otherwise, the divided sections or embodiments are not irrelevant to one another, but one section or embodiment has a relation of modifications, details and supplementary explanations to some or all of the other embodiments. The respective embodiments may be implemented, individually, or may be implemented in combination.

In addition, in the following embodiments, when the number (including count, figure, amount, and range) of the components is mentioned, the number of components is not limited to a specific number and may be greater than, less than or equal to the specific number, unless clearly specified otherwise and definitely limited to the specific number in principle.

Furthermore, there is no need to say that, in the following embodiments, the components (including component steps, etc.) are not always essential, unless clearly specified otherwise and considered to be definitely essential in principle.

Similarly, when shapes and positional relationships, etc. of the components are mentioned in the following embodiments, the components will have shapes substantially analogous or similar to their shapes or the like, unless clearly defined otherwise and considered not to be definite in principle. This is applied likewise to the above-described numerical values and ranges as well.

### First Embodiment

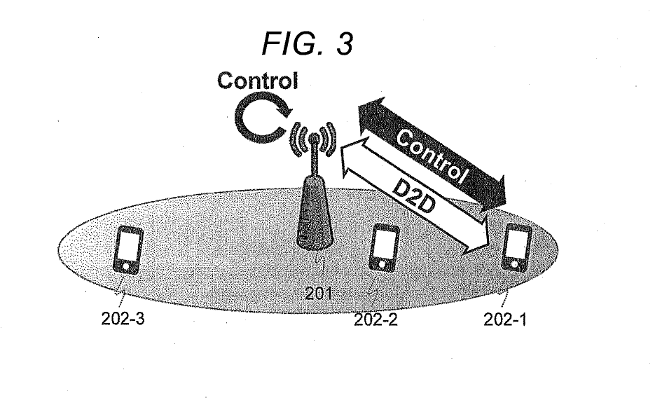

FIG. 3 is a conceptual diagram of a radio communication system according to a first embodiment according to the present invention.

A base station 201 forms a communication area (also called “cell”), and terminals 202 (202-1 to 202-3) are present within the communication area. The base station 201 measures a downlink traffic volume and an uplink traffic volume, or a usage status of radio resources. When the base station 201 detects that downlink radio resources get tight while uplink radio resources are redundant, the base station 201 starts the operation as a D2D device. That is, the base station 201 starts the operation as a device that performs communication with the terminals with the use of the uplink radio resources. The base station 201 notifies the terminal (terminal 202-1 in the example of FIG. 3) of control information (control) for D2D communication. Also, the base station 201 notifies a cellular unit and a D2D unit in the base station 201 of the same control information (control) as will be described later. Processing for performing the D2D communication is implemented between the base station 201 and the terminal 202-1, and thereafter the D2D communication is performed between the base station 201 and the terminal 202-1 with the use of the uplink resources.

In this situation, data to be transmitted to the terminal 202-1 by the base station 201 through the D2D communication is downlink data to the terminal 202-1 in a cellular communication. Data to be transmitted by the terminal 202-1 to the base station 201 through the D2D communication is uplink data in the cellular communication. That is, in the radio communication system according to this embodiment, the base station 201 can transmit or receive the traffic of the terminal 202-1 with the use of only the redundant uplink resources. As a result, even in a status where the downlink resources get tight, the redundant uplink resources can be effectively used, and the accommodatable traffic volume can increase.

Also, because the base station 201 can perform the D2D communication with all of the terminals 202 located in a communication area of the base station 201, there can be solved such a problem that the D2D communication cannot be performed between the terminals 102-1 and 102-3 because those terminals fall outside the coverage in the example of FIG. 2. Further, because the base station 201 can communicate another terminal or an application server through a core network, the base station 201 can communicate with the terminal 202-1 through a communication system of the D2D communication regardless of a communication destination of the terminal 202-1. In addition, because a resource ratio between the downlink and the uplink is kept constant for terminals (terminal 202-2 and terminal 202-3) other than the terminal 202-1 with which the base station 201 performs the D2D communication, there is no need to recognize whether the base station 201 starts the D2D communication, or not, and an overhead for the control and an influence on the terminals can be minimized.

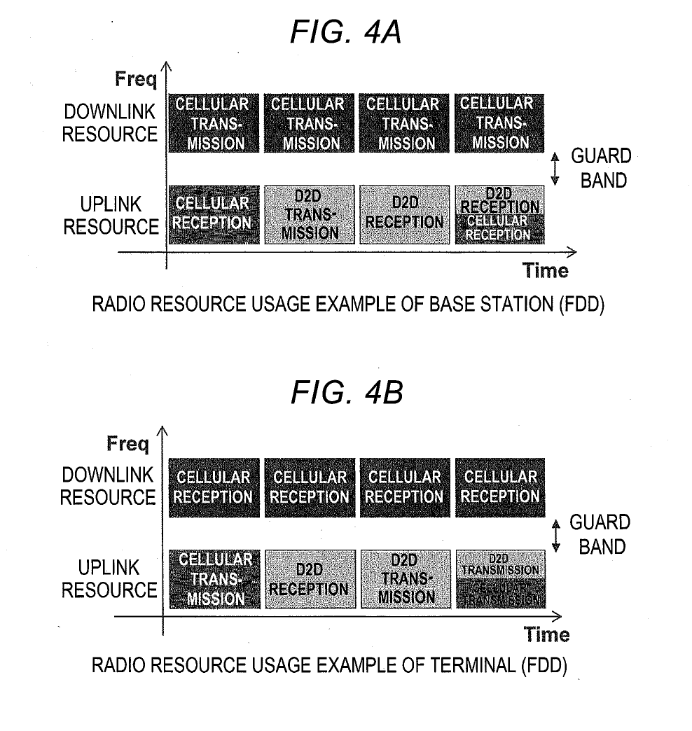

FIGS. 4A and 4B illustrate a usage example of the radio resources of the base station and the terminals in an FDD according to this embodiment. As illustrated in FIGS. 4A and 4B, in the FDD, the downlink resources and the uplink resources are different in frequency from each other, and a guard band is provided between the downlink frequency and the uplink link frequency. In the related art radio communication system, the base station 201 conducts the transmission of a cellular system (cellular transmission) in the downlink resources, and conducts the reception of the cellular system (cellular reception) in the uplink resources. The base station according to this embodiment is identical with the related art in that the cellular transmission is conducted in the downlink resources. In the uplink resources, signal transmission in the D2D communication (D2D transmission) is conducted in one period, and signal reception in the D2D communication (D2D reception) is conducted in another period. The D2D reception and the cellular reception may be conducted at the same time. A case in which the D2D transmission and the cellular reception are conducted at the same time will be described later. When the D2D transmission or the D2D reception is not conducted, the cellular reception is conducted as in the related art.

The terminal according to this embodiment conducts the operation opposite to that of the base station. That is, the cellular transmission is conducted in one period as in the related art, and the D2D reception or the D2D transmission is conducted in another period. Also, the D2D transmission and the cellular transmission may be conducted at the same time. A case in which the D2D reception and the cellular transmission are conducted at the same time will be described later. In this example, a usage example of the radio resources in the terminal of FIG. 4B may represent the operation of a specific terminal, or the operation of terminals different from each other.

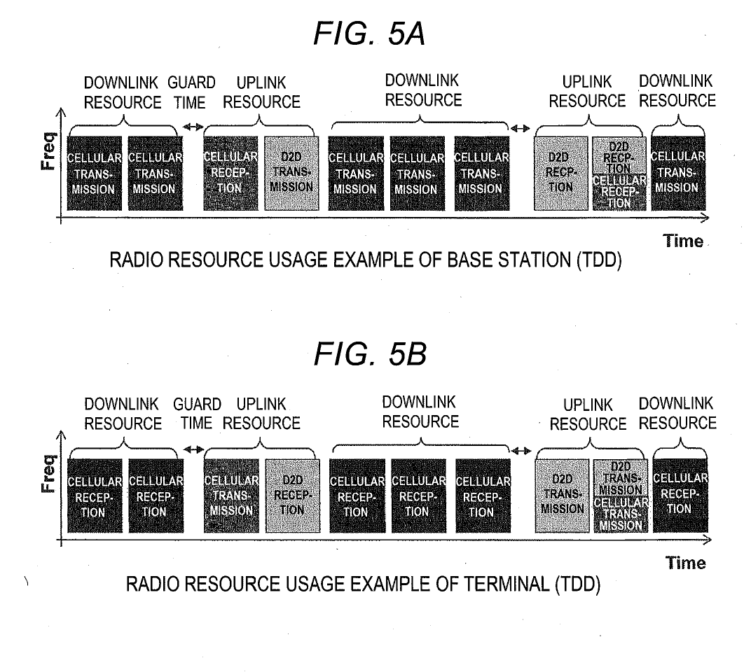

FIGS. 5A and 5B illustrate a usage example of the radio resources in the base station and the terminals in the TDD according to this embodiment. In the TDD, the downlink resources and the uplink resources are different in time slot from each other, and a guard time may be provided between the downlink time slot and the uplink time slot. The basic operation is identical with that in the FDD, and a relationship between the link resources and the downlink resources is merely converted into time from frequency.

Hereinafter, a case of the FDD will be exemplified because the generality is not lost. As in the relationship between FIGS. 4A and 4B and FIGS. 5A and 5B, the present invention can be easily realized even in the TDD with the conversion of frequency into time.

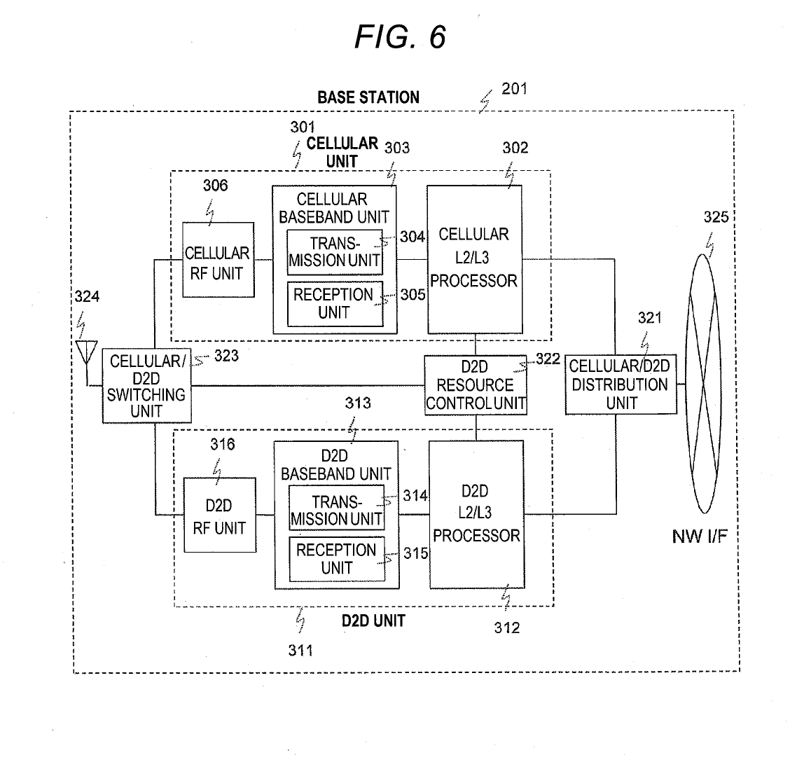

FIG. 6 illustrates an example of a device configuration of the base station 201 according to this embodiment. The device illustrated in FIG. 6 can be realized by a memory, a DSP (digital signal processor), an FPGA (field programmable gate array), a CPU (central processing unit), or an MPU (micro-processing unit). Also, for example, a CPU executes a variety of programs recorded in the memory to realize functions of the base station which will be described later. The base station 201 roughly includes a cellular unit 301 that performs cellular communication, a D2D unit 311 that performs the D2D communication, a portion that conducts switching and control of the cellular communication and the D2D communication, an antenna 324, and a network interface (NW I/F) 325.

The cellular unit 301 includes a cellular L2/L3 processor 302, a cellular baseband unit 303, and a cellular RF unit 306. The cellular L2/L3 processor 302 is configured to conduct processing of Layer 2 and Layer 3 for cellular communication of the base station. The cellular L2/L3 processor 302 stores cellular communication data of the respective terminals which is transmitted from a cellular/D2D distribution unit 321, and control signals received from other base stations or a mobility management entity (MME) in a buffer. Also, the cellular L2/L3 processor 302 conducts scheduling for determining a terminal that performs the cellular communication, and time and frequency resources to be allocated to that terminal, the management of an HARQ, retransmission processing of Layer 2 (RLC (radio link control)), processing of packets, concealment processing of a radio line, the control of handover, and the generation of the control signal in a higher layer to the terminals. The cellular L2/L3 processor 302 outputs a generated downlink packet to the cellular baseband unit 303. Also, the cellular L2/L3 processor 302 conducts packet processing of a bit sequence input from the cellular baseband unit 303, and outputs the packet to the cellular/D2D distribution unit 321. Further, as will be described later, the cellular L2/L3 processor 302 conducts parameter setting and scheduling of the various terminals on the basis of D2D communication resource information notified from a D2D resource control unit 322.

The cellular baseband unit 303 includes a cellular transmission unit 304 and a cellular reception unit 305, and mainly conducts signal processing in a physical layer (L1, layer 1) of the cellular communication. For example, the cellular transmission unit 304 conducts signal processing in a physical layer of a physical data channel or a physical control channel of the downlink in the respective terminals which is input from the cellular L2/L3 processor 302, and the generation of the control channel in the physical layer. The physical data channel may be also called “PDSCH (physical downlink shared channel) in the LTE (long term evolution) standard. The physical control channel may be also called “PDCCH (physical downlink control channel)”, “EPDCCH (enhanced PDCCH)”, “PHICH (physical hybridARQ indicator channel)”, or “PCFICH (physical control format indicator channel)”. Also, the cellular transmission unit 304 conducts the generation of reference signals (CRS (cell specific reference signal), CSI-RS, DMRS (demodulation RS), etc.) used for the terminal to conduct propagation path estimation for demodulation, the measurement of radio channel information (CSI (channel state information)), and the measurement of a reception power, and the insertion of the reference signals into the radio resources. The cellular transmission unit 304 also conducts the generation of a synchronization signal and a broadcast channel (PBCH) of the physical layer, and the insertion of the synchronization signal and the broadcast channel into the radio resources. The signal processing of the downlink in the cellular transmission unit 304 is, for example, error correction coding of the data signals and the control signals, MIMO signal processing such as rate matching, modulation, layer mapping, or precoding, mapping to the radio resources (also called “RE (resource element)”), and an IFFT (inverse fast Fourier transform). The baseband signal of the downlink generated in the cellular transmission unit 304 is output to the cellular RF unit 306.

The cellular reception unit 305 conducts signal processing in the physical layer such as an uplink data channel (PUSCH (physical uplink shared channel)) and an uplink control channel (PUCCH (Physical Uplink Control Channel)) which are input from the cellular RF unit 306. The uplink signal processing conducted by the cellular reception unit 305 includes demapping of the FFT and the RE, the MIMO signal processing such as the multiplication of MIMO reception weight or layer demapping, demodulation, or error correction decoding. The cellular reception unit 305 also conducts channel estimation, reception power measurement, and uplink CSI measurement using the uplink reference signal (DMRS or SRS (sounding RS)). The decoded data channel and control channel, and the various measurement results such as CSI are output to the cellular L2/L3 processor 302.

The cellular RF unit 306 has an RF (radio frequency) function. The cellular RF unit 306 converts a downlink cellular baseband IQ signal input from the cellular baseband unit 303 into an RF signal of the cellular system, and outputs the RF signal to a cellular D2D switching unit 323. Also, the cellular RF unit 306 converts the RF signal of the uplink cellular system which is input from the cellular D2D switching unit 323 into a baseband IQ signal, and inputs the baseband IQ signal to the cellular baseband unit 303. The cellular RF unit 306 also includes a power amplifier. Also, the cellular baseband unit 303 and the cellular RF unit 306 may be connected to each other by an optical fiber. In this case, the cellular RF unit 306 may include an electro-photo converter or a photoelectric converter.

The antenna 324 transmits and receives cellular RF signals and D2D RF signals of the uplink and the downlink, and plural antennas 324 may be provided.

A D2D L2/L3 processor 312 conducts the processing of Layer 2 and Layer 3 in the D2D communication. The D2D L2/L3 processor 312 controls a D2D baseband unit so as to transmit and receive a D2D signal with the use of timing and the frequency resource notified from the D2D resource control unit 322. Also, the D2D L2/L3 processor 312 conducts packet processing of the D2D communication. The D2D L2/L3 processor 312 also detects a terminal of a partner that performs D2D communication.

A D2D baseband unit 313 includes a D2D transmission unit 314 and a D2D reception unit 315. The D2D transmission unit 314 conducts baseband processing of a signal transmitted to the terminals 202 by the base station 201 in the D2D communication. The D2D reception unit 315 conducts baseband processing of a signal received from the terminals 202 by the base station 201 in the D2D communication.

In this example, when a communication system in the D2D communication is identical with that in the downlink of the cellular communication, that is, when the communication system is, for example, an OFDMA (orthogonal frequency division multiple access), the D2D transmission unit 314 functions as an OFDMA transmitter. In this case, the processing of the D2D transmission unit 314 may be identical with that of the cellular transmission unit 304, or may provide a function of only a part of the cellular transmission unit 304. Alternatively, the D2D transmission unit 314 and the cellular transmission unit 304 may be configured by a common device. On the other hand, the D2D reception unit 315 functions as an OFDMA receiver. In this case, because no OFDMA receiver is provided in the related art base station, another device different from the cellular reception unit 305 needs to be provided.

If the communication system in the D2D communication is identical with the uplink communication system in the cellular communication, that is, when the communication system is, for example, an SC-FDMA (single carrier-FDMA), the D2D transmission unit 314 functions as an SC-FDMA transmitter. In this case, because no SC-FDMA transmitter is provided in the related art base station, the D2D transmission unit 314 needs to be another device different from the cellular transmission unit 304. On the other hand, the D2D reception unit 315 may be identical with the cellular reception unit 305, or have a function of only a part of the cellular reception unit 305. Alternatively, the cellular reception unit 305 and the D2D reception unit 315 may be configured by a common device.

A D2D RF unit 316 conducts the conversion of a D2D baseband signal into a D2D RF signal, and the conversion of the D2D RF signal into the D2D baseband signal. Also, the D2D RF unit 316 also includes a power amplifier. Further, when the D2D RF unit 316 conducts D2D transmission and D2D reception at the same time as will be described later, the D2D RF unit 316 conducts a filtering process according to an instruction from a D2D L2/L3 processor, or a predetermined rule. If a complex communication system is TDD, because the downlink frequency and the uplink link frequency are identical with each other, the D2D RF unit 316 may be a device common to the cellular RF unit 306. If the duplex scheme is FDD, because the D2D RF unit 316 is identical in frequency with the cellular reception in the reception RF processing, the D2D RF unit 316 may be common to the cellular RF unit 306. In the transmission RF processing of the D2D RF unit 316, the RF processing of a D2D transmission signal such as frequency conversion into the uplink link frequency is conducted.

The network I/F 325 is an interface for connecting the core network to the base station 201 through a backhaul line. The network I/F 325 performs communication between the base station, and a gateway, the mobility management equipment, or another base station. Data and control information for cellular communication, and data and control information for D2D communication which are input from the core network are input to the cellular/D2D distribution unit 321.

The cellular/D2D distribution unit 321 transfers a signal input from the NW I/F to the cellular L2/L3 processor 302 or the D2D L2/L3 processor 312 according to the type of information. That is, the cellular/D2D distribution unit 321 functions as a router or a switch. When each of the cellular unit 301 and the D2D unit 311 has the NW I/F 325 independent from each other, the cellular/D2D distribution unit 321 may be eliminated.

The D2D resource control unit 322 is configured to determine the cellular communication radio resources and the D2D communication radio resources according to the uplink and downlink traffic statuses in the cellular communication, and the usage status of the radio resources. A method of allocating the D2D radio resources in the D2D resource control unit 322 will be described later. Also, the D2D resource control unit 322 notifies the cellular L2/L3 processor 302 and the D2D L2/L3 processor 312 of information on the cellular communication radio resources and the D2D communication radio resources which are determined. Further, the D2D resource control unit 322 controls the cellular D2D switching unit 323 according to a timing of switching between the cellular communication and the D2D communication, and the allocation status of the frequency resources. Also, the D2D resource control unit 322 may also control the filter setting of the cellular RF unit 306 and the D2D RF unit 316.

The cellular D2D switching unit 323 transfers a cellular transmission signal (downlink signal) or the D2D transmission signal to the antenna 324 according to an instruction from the D2D resource control unit 322. Also, the cellular D2D switching unit 323 transfers a cellular reception signal (uplink signal) or a D2D reception signal to the cellular RF unit 306 or the D2D RF unit 316 according to an instruction from the D2D resource control unit 322. The cellular D2D switching unit 323 may merely synthesize (combine) the cellular transmission signal and the D2D transmission signal, and output a synthesis signal to the antenna 324. Also, the cellular D2D switching unit 323 may merely replicate (demultiplex) the signal input from the antenna 324, and output the replicated signals to the cellular RF unit 306 and the D2D RF unit 316.

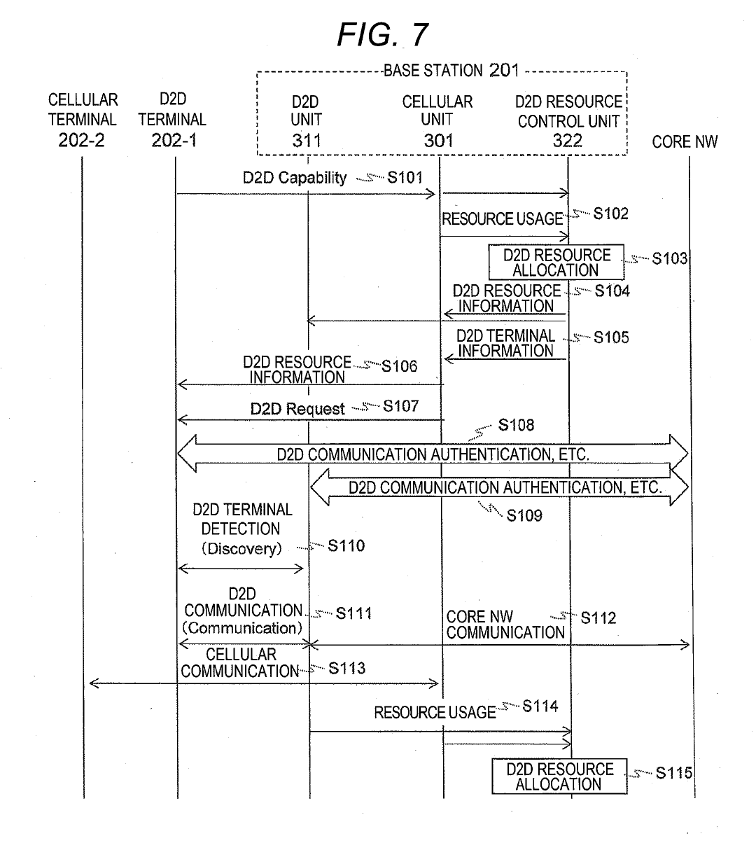

FIG. 7 illustrates an example of an operation procedure according to the first embodiment of the present invention. For description, the terminals that perform the D2D communication are denoted by the D2D terminal 202-1, and the other terminal is denoted by the cellular terminal 202-2, but the D2D terminal 202-1 also performs the cellular communication. Also, when there is no need to distinguish the D2D terminal and the cellular terminal from each other, the D2D terminal 202-1 and the cellular terminal 202-2 are merely denoted by the terminals 202. Also, in an initial state of FIG. 7, it is assumed that the base station 201 does not perform the D2D communication.

The cellular unit 301 in the base station 201 collects information indicative of whether the respective terminals 202 enable the D2D communication, or not, that is, D2D capability from the respective terminals 202 (S101). The D2D capability may be transmitted by the terminal on the basis of a request from the base station. Also, the cellular unit 301 notifies the D2D resource control unit 322 of the collected D2D capability. The cellular unit 301 calculates the usage rate of the uplink radio resources and the downlink radio resources in the cellular communication, and notifies the D2D resource control unit 322 of the radio resource usage rate (S102). The D2D resource control unit 322 allocates the D2D resources on the basis of the D2D capability of the respective terminals 202 and the radio resource usage rate which are received from the cellular unit 301 (S103). Although a specific method will be described later, if the downlink resources get tight, and the uplink resources are redundant, the D2D resource control unit 322 determines that the base station performs the D2D communication, and allocates the uplink resources used for the D2D communication. The D2D resource control unit 322 notifies the cellular unit 301 and the D2D unit 311 of the information on the allocated D2D resources (S104).

Also, the D2D resource control unit 322 communicates with the cellular unit 301, selects a terminal (D2D terminal 202-1) that performs D2D communication from the terminals 202 having the D2D capability, and notifies the cellular unit 301 of information on the selected terminal (S105). A method of selecting the D2D terminal 202-1 will be described later.

The cellular unit 301 notifies the D2D terminal 202-1 selected in S105 of the information (hereinafter referred to as “D2D resource information”) on the D2D communication radio resources notified from the D2D resource control unit 322 in S104 (S106). In this example, the cellular terminal 202-2 that does not perform the D2D communication, and the terminals 202 having no D2D capability not shown do not need to grasp whether the base station 201 performs the D2D communication, or not. This is because the terminals other than the D2D terminal 202-1 do not need to receive the D2D signals transmitted by the base station 201 with the use of the uplink resources. Therefore, the information on the uplink resources may be notified only the D2D terminal 202-1 of. On the other hand, in the related art radio communication system that allocates all or a part of the uplink resources as the downlink resources, there is a need to notify all of the terminals that the resource distribution of the uplink and the downlink has been changed. The same is applied to a case in which the uplink resources allocated to the downlink are released and again set as the uplink. As described above, in the radio communication system according to this embodiment, the overhead for control can be reduced as compared with a case in which the resource ratio of the uplink and the downlink is changed.

However, the system information to be broadcasted in the cellular system may be transmitted with the inclusion of the information on the D2D resources. The reason is because, for example, if the terminals that perform the D2D communication between the respective terminals other than the D2D terminal 202-1 are present, the terminals other than the D2D terminal 202-1 need to grasp the information on the D2D radio resources. For that reason, for example, the base station 201 may determine whether the information on the D2D resources is broadcasted, or not, according to the status of the D2D capability of the terminals, or whether a request for allocating the D2D communication radio resources to be sent from the terminal. Also, the information on the D2D resources to be notified the D2D terminal 202-1 which becomes a communication partner of the D2D unit 311 in the base station 201 may be different from the information (for example, information to be broadcasted) on the D2D resources allocated to the D2D communication between the other respective terminals.

Then, the cellular unit 301 in the base station 201 transmits a request for D2D communication (D2D request) to the D2D terminal 202-1 (S107). Then, the D2D terminal 202-1 communicates with the core NW through the base station 201 (cellular unit 301 thereof), and authenticates the D2D communication (S108). At the same time, the D2D unit 311 of the base station 201 also authenticates the D2D terminal (S109). The D2D unit 311 and the D2D terminal 202-1 transmit signals (D2D discovery signals) for mutually detecting devices performing the D2D communication to each other, and detect partners of the D2D communication (S110). S110 may be also called “D2D discovery”. Also, the D2D discovery may include a procedure of synchronizing the D2D terminal 202-1 and the D2D unit 311 with each other. Also, a standard for synchronization in the D2D communication may be a synchronization signal transmitted by the cellular unit 301 of the base station 201 in the downlink.

When the D2D terminal 202-1 and the D2D unit 311 detect the respective presences, the D2D terminal 202-1 and the D2D unit 311 perform communication with the use of the uplink resources through the D2D communication (S111). S111 may be called “D2D communication”. A real communication partner of the D2D terminal 202-1, that is, an end-to-end communication partner is another terminal or an application server not shown. Therefore, the D2D unit 311 of the base station 201 transfers an IP packet received from the D2D terminal 202-1 to the real communication partner through the core NW (S112). Alternatively, the D2D unit 311 transmits the IP packet received through the core NW to the D2D terminal 202-1 after converting only the communication system into the D2D transmission.

Also, the base station 201 receives the uplink signal from the cellular terminal 202-2 in the same manner as that of the normal base station in the radio resources that have not been transmitted or received by the D2D unit 311. Also, as described above, the base station 201 conducts the downlink cellular transmission in the same manner as that of the normal base station in the downlink (S113).

Also, the D2D unit 311 and cellular unit 301 periodically inform the D2D resource control unit 322 of the traffic volumes of the D2D communication and the cellular communication or the usage rate of the radio resources (S114). The traffic volume of the cellular communication or the radio resource usage rate is informed for both of the uplink and the downlink. Then, the D2D resource control unit 322 again allocates the D2D resources on the basis of the informed traffic volume (S115).

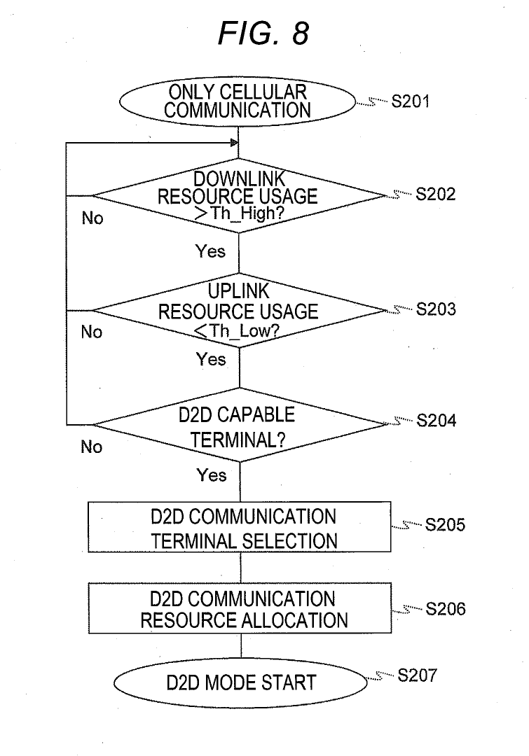

FIG. 8 illustrates an example of the D2D resource allocation (corresponding to S103) in the D2D resource control unit 322 when the D2D communication is not conducted. The D2D resource allocation in FIG. 8 is periodically implemented. In an initial state, the base station 201 performs only the cellular communication (S201). The D2D resource control unit 322 determines whether the downlink resource usage rate notified from the cellular unit 301 is larger than a first threshold value (Th_High) or not (S202). If the resource usage rate of the downlink is equal to or smaller than Th_High (No in S202), the D2D resource control unit 322 determines that the downlink radio resources are redundant, or that the downlink traffic volume is small, and D2D resource control unit 322 does not perform the D2D communication. If the resource usage rate of the downlink is larger than Th_High (Yes in S202), the D2D resource control unit 322 determines that the downlink radio resources get tight.

Then, the D2D resource control unit 322 determines whether the uplink radio resource usage rate is smaller than a second threshold value (Th_Low) or not (S203). If the uplink radio resource usage rate is equal to or larger than Th_Low (No in S203), the D2D resource control unit 322 determines that the uplink radio resources are not redundant for the D2D communication, that is, the downlink traffic cannot be transmitted with the use of the uplink resources, and the D2D communication is not performed. If the uplink radio resource usage rate is smaller than Th_Low (Yes in S203), the D2D resource control unit 322 determines that the uplink radio resources are redundant. In this example, Th_High may be larger than Th_Low.

Subsequently, the D2D resource control unit 322 determines whether a D2D communicatable terminal (D2D compatible terminal) is present within a communication area of the base station 201, or not, on the basis of the D2D capability notified from the cellular unit (S204). If the D2D compatible terminal is not present (No in S204), the D2D communication is not performed (disabled). If the D2D compatible terminal is present (Yes in S204), the D2D resource control unit 322 determines that the D2D communication is performed.

Then, the D2D resource control unit 322 selects a terminal with which the base station 201 performs the D2D communication from the D2D compatible terminals (S205). Various methods can be employed as selection standards of the terminals. For example, when the terminals 202 larger in the downlink traffic volume are selected, the downlink traffic that gets tight may be off-loaded in the uplink. Alternatively, as will be described later, the terminals closer to the base station 201 may be selected. Also, because the D2D communication is basically performed in time division with the use of only the uplink, the terminal not strict in a request for delay time may be selected taking a fact that the delay time is large as compared with the cellular communication into account. Alternatively, the terminal may be determined according to the downlink traffic volume of the terminal, the remaining amount uplink resources, or a downlink radio quality status. Also, one terminal may be selected, or plural terminals may be selected in S205.

Then, the D2D resource control unit 322 determines the amount of resources to be allocated to the D2D communication within the uplink radio resources. The amount of uplink radio resources to be allocated to the D2D communication is determined on the basis of the traffic volume of the terminal that performs the D2D communication, and the uplink radio resource usage rate. For example, when the overall uplink radio resources is 1, the amount of uplink radio resources that is (1-uplink resource usage rate) may be allocated to the D2D communication. Also, the amount of radio resources obtained by subtracting a given margin from (1-uplink resource usage rate) may be allocated to the D2D communication. Alternatively, the amount of radio resources that enables the traffic volume of the terminal determined in S205 to be transmitted may be allocated to the D2D communication. The D2D communication radio resources include one or plural sub-frame numbers of the uplink, and the sub-frames designated for each of radio frames (10 msec in LTE) may be allocated as the radio resources for the D2D communication. Alternatively, the D2D communication radio resources may be configured by the sub-frame numbers, and their cycles. Further, the frequency resources may be designated in addition to the sub-frame numbers (that is, time resources).

When the D2D resource control unit 322 determines the terminal that performs the D2D communication, and the radio resources used for the D2D communication, the D2D resource control unit 322 starts a communication mode (S207). Also, the D2D resource control unit 322 notifies the cellular unit 301 and the D2D unit 311 of information on the terminal that performs the D2D communication and the radio resources used for the D2D communication.

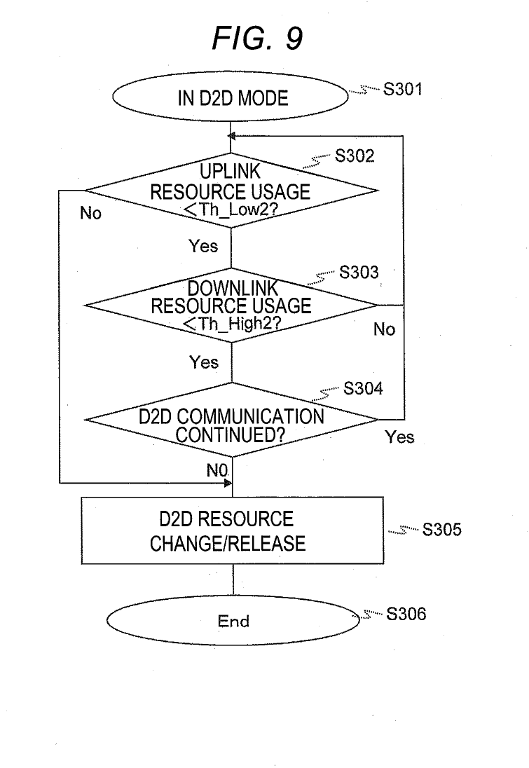

FIG. 9 illustrates an example of the D2D resource allocation when the base station 201 performs the D2D communication (corresponding to S115). In S301, it is assumed that the base station 201 performs both of the cellular communication and the D2D communication. The D2D resource control unit 322 determines whether the uplink resource usage rate is smaller than a third threshold value (Th_Low2) or not (S302). If the uplink usage rate is equal to or larger than Th_Low2 (No in S302), the D2D resource control unit 322 determines that the uplink resources does not become redundant, changes or releases the D2D resources (S305), and completes the D2D resource allocation processing. The changed or released D2D resource information is notified the cellular unit 301 and the D2D unit 311 of. Specifically, the amount of D2D communication radio resources is reduced more than the current allocation. Alternatively, the D2D resource control unit 322 completely releases the D2D radio resources, and completes the D2D communication. If the D2D resource control unit 322 determines that the uplink radio resources get tight, the D2D resource control unit 322 reduces or releases the amount of D2D communication radio resources, thereby enabling the cellular uplink traffic to be communicated preferentially. In this example, the uplink resource usage rate includes both of the resource usage rate of the uplink communication in the cellular communication, and the resource usage rate in the D2D communication.

If the uplink usage rate is smaller than Th_Low2 (Yes in S302), the D2D resource control unit 322 determines that the uplink resources still become redundant. Then, the D2D resource control unit 322 determines whether the downlink resource usage rate is smaller than a fourth threshold value (Th_High2) or not (S303). If the downlink resource usage rate is equal to or larger than Th_High2 (No in S303), the D2D resource control unit 322 determines that the uplink resources are redundant, and the downlink resources get tight, and continues the D2D communication. In this situation, the D2D resource control unit 322 may increase the D2D radio resources as occasion demands. If the downlink resource usage rate is smaller than Th_High2 (Yes in S303), the D2D resource control unit 322 determines that the downlink resources are redundant. Then, the D2D resource control unit 322 determines whether the D2D unit 311 continues the D2D communication with any D2D terminal 202-1, or not (S304). If there is ongoing D2D communication (Yes in S304), the D2D resource control unit 322 determines that there is no need to stop the ongoing D2D communication because redundancy occurs in the downlink resources, but the uplink resources are still redundant. Then, the D2D resource control unit 322 continues the D2D communication. If there is no ongoing D2D communication (No in S304), the D2D resource control unit 322 changes or releases the D2D resources (S305), and completes the D2D resource allocation (S306) because the redundancy occurs in the downlink resources. In this example, the operation in S304 may be eliminated. In that case, for example, if the redundancy occurs in the downlink resources, the D2D resource control unit 322 releases the D2D resources, and completes the D2D communication. If it is thus determined that the redundancy occurs in the downlink radio resources, the D2D resource control unit 322 reduces the amount of radio resources for D2D communication, or releases the D2D resources, thereby enabling the cellular uplink traffic to be communicated preferentially.

However, Th_Low2 and Th_High2 may have the same values as, or different values from those of Th_Low and Th_High, respectively. For example, when it is assumed that Th_Low2 is smaller than Th_Low, if the redundancy is eliminated from the uplink resources, the D2D communication is likely to be completed, and the cellular uplink traffic can be communicated preferentially. When Th₁₃ High2 is set to be larger than Th_High, if the redundancy even slightly occurs in the downlink resources, the D2D communication is likely to be completed, and the downlink traffic is transmitted in the original cellular downlink communication.

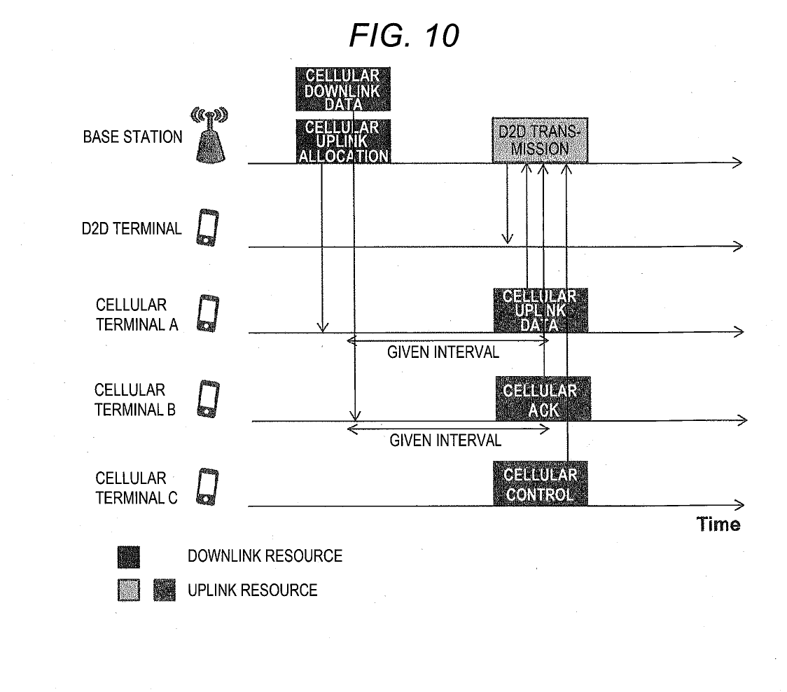

FIG. 10 is a diagram illustrating an example of a problem with the radio communication system according to this embodiment. The base station according to this embodiment transmits and receives the D2D signal while transmitting and receiving the cellular signal. However, in the cellular system, there is a need to divide the uplink communication and the downlink communication by time (TDD) or frequency (FDD). Likewise, the base station needs to divide the D2D transmission and the cellular reception in the uplink resources by time or frequency. Therefore, in the time at which the base station transmits the D2D signal, and the frequency resources, the base station needs to control the uplink communication in the cellular system not to be conducted. The uplink signal in the cellular system can be classified into uplink data and uplink control signals (also called “UCI (uplink control information)”). In this example, in FIG. 10, for description, the uplink control signals can be classified into the ACK to the downlink data, and others.

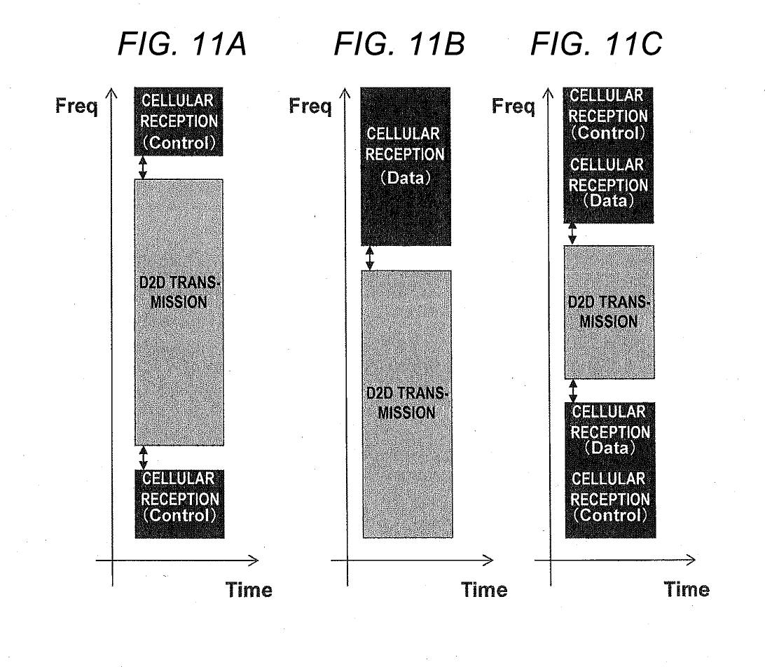

For example, when the base station allocates the resources to the uplink data transmission to a cellular terminal A, that is, schedules the uplink data transmission, the cellular terminal A conducts the uplink data transmission after a given interval determined in conformity to the standard. For that reason, when the base station schedules the uplink without taking that the D2D transmission is conducted with the use of the uplink radio resources into account, there is a possibility that a timing at which the base station conducts the D2D transmission overlaps with a timing at which the base station receives the cellular uplink data. As a result, the D2D transmission signal transmitted by the base station interferes with the cellular uplink data, resulting in a possibility that the reception quality of the cellular uplink data reception is greatly degraded. Therefore, the base station according to this embodiment controls the cellular uplink data communication resources to be not allocated at a given time interval before a timing at which the base station conducts the D2D transmission. Alternatively, as illustrated in FIGS. 11A to 11C, the base station controls the frequencies of the uplink data reception and the D2D transmission to be different from each other. This can solve such a problem that the times or the frequency resources of the D2D transmission and the cellular reception related to the uplink data overlap with each other.

Also, when the base station transmits the cellular downlink data, for example, to a cellular terminal B, the cellular terminal B transmits an ACK (or NACK) signal to the downlink data to the base station after a given time interval. For that reason, as with the cellular uplink data, the timing at which the base station conducts the D2D transmission overlaps with the timing at which the base station receives the ACK to the cellular downlink data, resulting in a possibility that the reception quality of the ACK to the cellular downlink data is degraded. On the other hand, in the radio communication system according to this embodiment, when the D2D transmission is conducted, it is undesirable to stop the downlink data transmission for the purpose of preventing the timings of the D2D transmission and the cellular reception related to the ACK from overlapping with each other because the downlink traffic volume is large. Therefore, as in the uplink data communication, it is undesirable to control the downlink data transmission to be not conducted at a given time interval before the timing at which D2D transmission is conducted. For that reason, as illustrated in FIGS. 11A to 11C, the base station according to this embodiment controls the ACK to the cellular downlink data, and the D2D transmission to use the different frequency resources.

Also, a cellular terminal C transmits the cellular uplink control signal at a given timing designated from the base station (except for ACK). The uplink control signal includes, for example, downlink radio channel information (also called “CSI (channel state information)”), an uplink resource allocation request (SR (Scheduling request)), a sounding reference signal (SRS (sounding RS)) for the base station to measure the uplink radio channel, and a random access signal. The transmission timing of those uplink control signal is determined according to parameters of a higher layer from the base station. Therefore, when the base station determines the parameters of the uplink control signals without taking that the base station conducts the D2D transmission into account as in the related art basic station, the timing of the D2D transmission may overlap with the reception timing of the cellular uplink control signals. As a result, the D2D transmission signal interferes with the cellular uplink control signal, resulting in a possibility that the reception quality of the uplink control signal is greatly degraded. For that reason, the base station according to this embodiment determines the parameter of the higher layer for transmission of the cellular uplink control signal, and the radio resources allocated for the D2D communication so that the transmission timing of those control signals does not overlap with the timing of the D2D transmission. Alternatively, as illustrated in FIGS. 11A to 11C, the base station controls the frequencies of the cellular uplink control signals (except for ACK) reception and the frequency of the D2D transmission to be different from each other.

FIGS. 11A to 11C are diagrams illustrating examples where the frequency resources of the D2D transmission and the cellular reception are divided. FIG. 11A illustrates an example of frequency division of the cellular control signal and the D2D transmission signal. The cellular uplink control signals such as the cellular ACK, or the cellular CSI or SR illustrated in FIG. 10 are transmitted on both ends of the uplink frequency bandwidth. For that reason, the base station controls a bandwidth used for the D2D transmission to be in the vicinity of the center of an uplink band. A guard band may be provided between the D2D transmission signal and the cellular reception signal. For example, in S106 of FIG. 7, information on the frequency bandwidth or the resource block maybe notified as the radio resource information used for D2D communication. Then, the base station removes a portion of the radio signal for D2D transmission except for the radio resources for D2D transmission by a filter. Also, the base station removes a portion of the cellular reception signals except for the cellular reception signal by a filter.

FIG. 11B illustrates an example of frequency division of the cellular uplink data signal and the D2D transmission signal. As illustrated in FIG. 11B, when the timing of the cellular uplink data reception overlaps with the timing of the D2D transmission signal, the base station allocates the radio resources so that those bandwidths do not overlap with each other. Then, the base station removes a portion other than the D2D transmission signal or the cellular uplink data by the filter.

FIG. 11C illustrates an example of the frequency division of the cellular uplink control signal, the uplink data, and the D2D transmission signal. Taking that the cellular uplink control signal is located on both ends of the uplink bandwidth in account, the uplink data that overlaps with the timing of the D2D transmission may be allocated adjacent to an uplink control signal band.

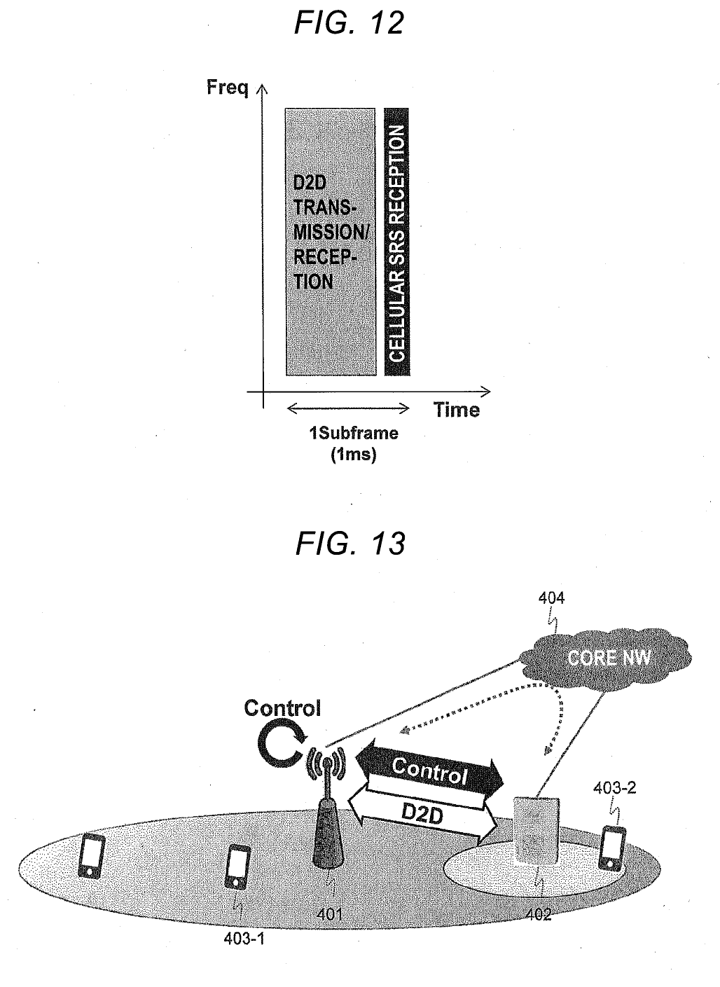

FIG. 12 illustrates an example of the time division of the cellular SRS and the D2D transmission or reception signal. The SRS may be over an extensive range of the uplink band, and the frequency division from the D2D transmission signal is difficult. As described above, the timing at which the terminal transmits the SRS, and the timing at which the base station transmits the D2D signal maybe at different time slots or subframes under the control. Alternatively, as illustrated in FIG. 12, the time division may be conducted within the same subframe. Because the SRS is transmitted by a last OFDM symbol in an uplink subframe, the base station may transmit the D2D signal with the use of an OFDM symbol other than the last OFDM symbol in the uplink subframe. Also, in order switch between the D2D transmission and the SRS reception, a given guard time maybe provided between the D2D transmission and the SRS. The same is applied to a case in which the timings of the SRS reception and the D2D reception in the base station overlap with each other. That is, in order to avoid an interference between the D2D reception signal and the SRS, the D2D signal may not use the last OFDM symbol.

### Second Embodiment

FIG. 13 is a conceptual diagram of a second embodiment according to the present invention. In the first embodiment, even if the uplink radio resources are redundant, there is a possibility that D2D communicatable terminals (terminals having the D2D capability) are not present. As a result, even if the base station has a function of performing the D2D communication, there is a possibility that the redundant uplink resources cannot be effectively utilized. Under the circumstances, in the second embodiment of the present invention, the D2D communication is performed between the base station and the base station in the uplink resources. As a result, even if the D2D communicatable terminals are not present within a communication area of the base station, the uplink resources can be effectively utilized. Also, because there is a high possibility that a gain of an antenna in the base station is larger than again of an antenna in the terminal, the D2D communication can be performed between the respective base stations largely distant from each other as compared with the D2D communication conducted between the base station and the terminal. Also, because the position of the base station is not changed differently from the terminal, the directivity faces in a specific direction, resulting in a possibility that the D2D communication can be performed between the base stations further distant from each other.

As illustrated in FIG. 13, a first base station 401 and a second base station 402 are located in an area where the first base station 401 and the second base station 402 can communicate with each other. FIG. 13 illustrates an example in which the first base station 401 is a macro cell base station larger in transmission power or communication area, and the second base station 402 is a small cell base station smaller in the transmission power or the communication area. However, both of the first base station 401 and the second base station 402 may be the macro cell base station, or may be the small cell base station. Also, the small cell may be a femto cell base station particularly called “home eNB” or “CSG (closed subscriber group) cell”. The first base station 401 and the second base station 402 may be connected to each other through a core network 404, may be connected directly to each other by a wired line, or may not be connected by wiring.

When the first base station 401 or the second base station 402 detects that the uplink radio resources are redundant, the base station starts the operation as the D2D device. A method of determining whether the uplink radio resources are redundant, or not, is identical with that in the first embodiment. The D2D communication is performed between the first base station 401 and the second base station 402 with the use of the uplink radio resources. In this example, if the terminal that can perform the D2D communication is not present, that is, if the terminal having the D2D capability is not present, the D2D communication may be performed between the first base station and the second base station. With this configuration, even when the D2D communicatable terminal is not present within the communication area of the base station, the uplink resources can be effectively utilized.

In this example, the information transmitted or received by the first base station 401 and the second base station 402 through the D2D communication may be backhaul control information. Specifically, for example, the above information may be the formation transmitted or received through a mobility management equipment or a gateway with the use of an interface called “S1” in the LTE standard. Also, the above information may be control information transferred between the respective base stations with the use of an interface called “X2”. Alternatively, data transfer for handover of the terminals may be conducted from the first base station 401 to the second base station 402 through the D2D communication, or data transfer may be conducted from the second base station 402 to first base station 401. Alternatively, a signal for synchronizing between the respective base stations may be transmitted or received through the D2D communication. Further, for example, the D2D communication may be used as a backhaul link of the second base station 402. That is, the first base station 401 may transmit downlink data, control information, or both of the data and the control information of a terminal (403-2) connected to the second base station 402, which are received from the core network 404 from the first base station 401 to the second base station 402. Also, the uplink data of the terminal (403-2) maybe transmitted from the second base station 402 to the first base station 401, and transferred to the core network 404 by the first base station 401.

As described above, the communication is performed between the base station and the base station with the use of the redundant uplink radio resources with the results that the uplink radio resources can be effectively utilized. Also, because a part or all of the backhaul communication can be implemented with the use of the cellular communication radio resources, the base station has no need to provide the wired backhaul line, and the installation of the base stations and the operation costs can be reduced. Alternatively, a required performance of the backhaul line of the base station can be reduced. In this example, the information transmitted and received by the first base station 401 and the second base station 402 through the D2D communication may be information of a third base station not shown. That is, the information exchanged between the first base station 401 and the third base station not shown may be relayed by the second base station.

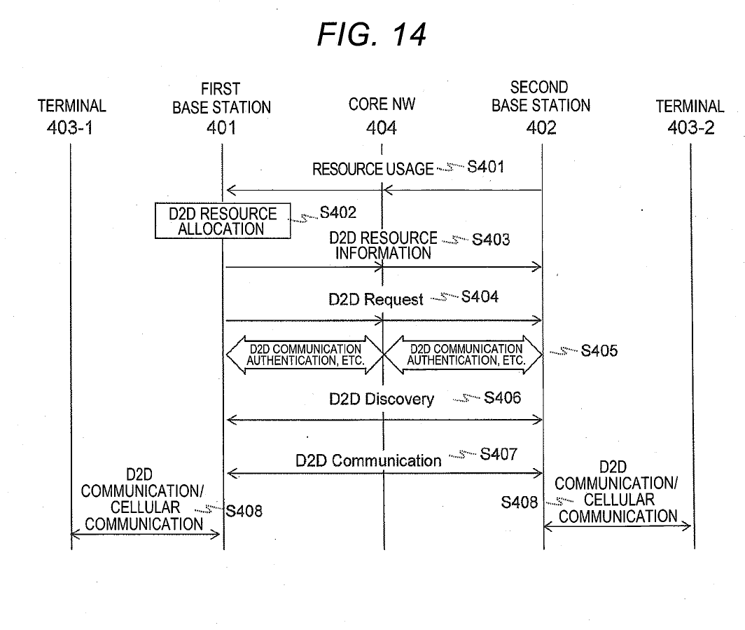

FIG. 14 is a diagram illustrating an example of an operation procedure according to the second embodiment of the present invention. As illustrated in FIG. 6, each of the first base station 401 and the second base station 402 includes the cellular unit 301, the D2D unit 311, and the D2D resource control unit 322. For simplification of the drawings, those components are omitted. The second base station 402 notifies the first base station of the usage rates of the uplink and downlink radio resources in the second base station 402 (S401). In FIG. 14, the second base station 402 notifies the usage rates through the core network 404, but the core NW may be eliminated. The first base station 401 determines the resources allocated to the D2D communication on the basis of the radio resource usage rates of the uplink and the downlink in the first base station 401, and the radio resource usage rate of the second base station notified from the second base station 402 (S402). Then, the first base station 401 notifies the second base station 402 of the information on the D2D communication radio resources (S403). Also, the first base station 401 transmits a request (D2D request) for performing communication through the D2D communication to the second base station 402 (S404). Thereafter, the first base station 401 and the second base station 402 exchange authentication for performing the D2D communication as occasion demands, information on a destination device (that is, first or second base station), and application information (for example, identifier indicative of backhaul information) between the core NW or the base stations (S405). The first base station 401 and the second base station 402 perform detection of the respective presences, and synchronization by the D2D discovery (S406). Then, the first base station 401 and the second base station 402 perform the D2D communication (D2D communication) (S407). Also, as indicated in S408, the first base station 401 performs the cellular communication or the D2D communication with a terminal 403-1 connected to the first base station in the time or frequency resources where the D2D communication is not performed between the respective base stations. Likewise, the second base station 402 may perform the cellular communication or the D2D communication with a terminal 403-2 connected to the second base station.

In this example, FIG. 14 illustrates an example in which the first base station 401 allocates the resources of D2D used for communication with the second base station 402. Alternatively, the uplink radio resources used for the D2D communication between the respective base stations may be determined in advance. Alternatively, information on the radio resource usage rates may be collected in another control device which is not the first base station 401 and the second base station 402 and the control device may determine the radio resources. Alternatively, the first base station 401 and the second base station 402 may determine the radio resources for the D2D communication on the basis of the respective radio resource usage rates, exchange the determined information on the radio resources for the D2D communication with each other, and determine the D2D communication radio resources by ANDing or ORing both of those base stations.

The radio resources used for the D2D communication between the respective base stations may be different from the radio resources used for the D2D communication between the base station and the terminal, or the radio resources used for the D2D communication between the respective terminals. The radio resources of the D2D communication between the respective base stations, the D2D communication between the base station and the terminal, and the D2D communication between the respective terminals can be distinguished from each other to prevent the respective D2D communications from interfering with each other.

### Third Embodiment

A third embodiment of the present invention is intended to effectively utilize the radio resources with the use of the frequency carriers different between the D2D communication and the cellular communication.

As illustrated in FIGS. 10 and 11, the D2D signal transmitted by the base station, and the uplink cellular signal received by the base station need to be divided by time or frequency. As described in the first embodiment, the overlap of the timing of the D2D transmission and the uplink data reception can be prevented by not scheduling the uplink data transmission to the terminal at timing when the base station conducts the D2D transmission. The overlap of the reception of the uplink control signal except for the ACK to the downlink data, and the timing of the D2D transmission can be avoided by setting the parameters of the higher layer so as to prevent the terminal from transmitting the uplink control signal at the timing of the D2D transmission. On the other hand, it is difficult to prevent the ACK to the downlink data from overlapping with the timing. Under the circumstances, as illustrated in FIGS. 11A to 11C, control can be effected so that the uplink control signal such as the ACK does not overlap with the bandwidth of the D2D transmission signal.

However, even in any cellular reception of the uplink data and the uplink control signal (including the ACK), a guard band needs to be provided between the frequency bandwidth used for the D2D transmission and the frequency bandwidth used for the cellular reception, resulting in such a problem that the usage rate of the radio resources is lowered. Also, in order to remove the signal out of the band, high-performance filter needs to be used, resulting in a possibility that the complexity of the signal processing of the base station increases. Under the circumstance, in the third embodiment of the present invention, the different frequency carriers are used between the D2D communication and the (uplink) cellular communication under the control.

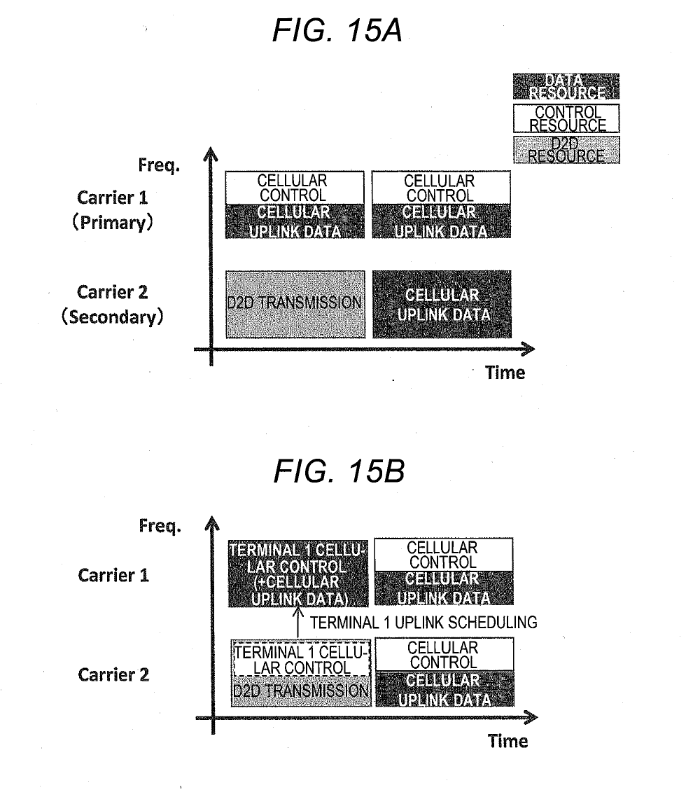

FIGS. 15A and 15B illustrate usage examples of the uplink radio resources according to the third embodiment of the present invention. In the third embodiment, it is assumed that the base station and the terminals use plural frequency carriers. A technique in which the terminals perform the communication with the use of the plural frequency carriers at the same time is called “carrier aggregation (CA)”. In the CA, in the plural frequency carriers, one frequency carrier is a primary component carrier (PCC) or a primary cell (PCell), and another or other plural frequency carriers become secondary component carriers (SCC) or secondary cell (SCell). Which frequency carrier is set as PCell can be set for each of the terminals. When CA is used, the uplink control information such as ACK, CSI, or SR is transmitted by only PCell. That is, the radio resources for control channel are defined by only the uplink sources of PCell. More specifically, the uplink control information such as ACK, CSI, or SR is transmitted by a physical channel such as PUCCH (physical uplink control channel). However, the resources of the PUCCH for the respective terminals are present in only the PCell of the respective terminals, but are not present in the SCell. Also, PCell are always present in all of the terminals, but SCell may be set, or may not be set.

A method of avoiding the collision of the D2D transmission and the cellular uplink control signals using the above features is illustrated in FIG. 15A. FIGS. 15A and 15B illustrate an example in which two frequency carriers are present. In FIG. 15A, a frequency for performing the D2D communication is fixed to a certain frequency carrier (carrier 2). Plural carriers 2 may be provided. A frequency carrier (carrier 1) that does not perform D2D communication becomes PCell or PCC for all of the terminals connected to the base station under the control. Specifically, when the frequency carrier at which the terminal conducts an initial access is the carrier 2, the base station hands over the terminal to the carrier 1. As a result, the PCell of the terminal becomes the carrier 1. When the carrier 2 is used, the base station sets the carrier 2 as the SCell for the terminal. As described above, the control is effected so that the frequency carrier (carrier 2) at which the D2D communication is performed becomes SCell in all of the terminals under the control. As a result, in the frequency carrier that performs the D2D transmission, the cellular uplink control signal, that is, the ACK to the downlink data is not transmitted, and the cellular uplink control signal is transmitted in the carrier 1 which is the PCell. As a result, the base station has no need to divide the frequency resources within the same frequency carrier to perform the communication for the D2D transmission and the cellular reception. That is, because the base station can use all of the frequency resources in the Subframe where a certain frequency carrier is present for D2D transmission, the amount of data transmittable in the D2D transmission can increase. Further, because the guard band is not also required, the uplink resource usage efficiency can be improved. Also, the high-performance filter in the base station is not required.

FIG. 15B illustrates another method of avoiding the overlap of the radio resources of the D2D transmission and the cellular reception with the use of CA. In the LTE standard, when the uplink data (that is, PUSCH) is scheduled, the terminal transmits the control signals such as ACK or CSI with the use of not the radio resources for the control channel (that is, PUCCH), but the radio resources for the scheduled uplink data (PUSCH). Under the circumstances, as illustrated in FIG. 15B, when the D2D transmission timing of the base station overlaps with the transmission timing of the cellular control information of the terminal in a certain frequency carrier, the uplink data of another frequency carrier is scheduled in the terminal. In this case, in the frequency carrier that conducts the D2D transmission, the cellular uplink control information is not transmitted, and the cellular uplink control information (and uplink data if data is present) is transmitted with the use of the radio resources for data of the different frequency carrier. As a result, as in the case of FIG. 15A, the base station has no need to divide the frequency resources within the same frequency carrier to perform the communication for the D2D transmission and the cellular reception. As a result, the usage efficiency of the uplink resource can be improved. Also, in the method of FIG. 15B, the PCell and SCell of the respective terminals can be set to arbitrary frequency carriers. Also, in the method of FIG. 15B, the frequency carrier that performs the D2D communication can be also set to an arbitrary frequency carrier.

### Fourth Embodiment

A fourth embodiment of the present invention is to reduce an interference of one base station with another base station which is caused by allowing one base station to perform the D2D communication with the use of the uplink resources, or an interference of the base station with the D2D terminal.

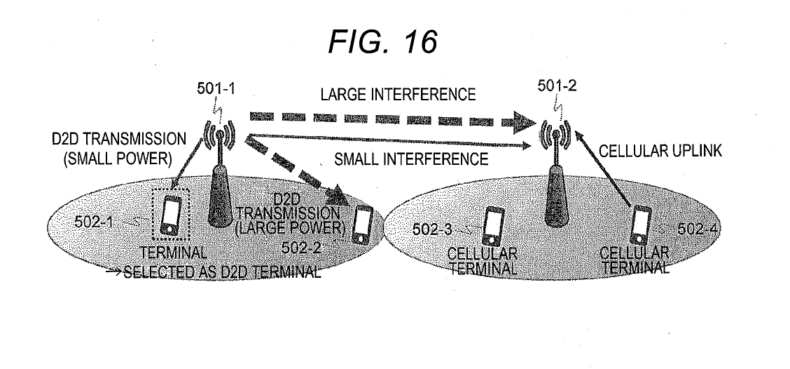

FIG. 16 is a conceptual diagram of a fourth embodiment according to the present invention. In FIG. 16, two terminals (502-1 and 502-2) each having the D2D capability are present within a communication area of a base station 501-1, and two cellular terminals (502-3 and 502-4) are present within a communication area of abase station 501-2 adjacent to the base station 501-1. The terminal 502-1 is located in the vicinity of the base station 501-1. The terminal 502-2 is located distant from the base station 501-1, and in the vicinity of a boundary of communication areas of the base station 501-1 and the base station 501-2.

In this example, it is assumed that the base station 501-1 detects that the downlink resources get tight, and the uplink resources redundant through the method illustrated in FIG. 8, and selects the D2D communication terminal. In this situation, as illustrated in FIG. 16, when the base station 501-1 selects the terminal 502-2 as the terminal that performs the D2D communication, the base station 501-1 has a need to conduct the D2D transmission with a large transmission power for performing the communication with the terminal 502-2. This leads to a possibility that an interference of the signal transmitted by the base station 501-1 with the cellular uplink signal in the base station 501-2 becomes large to degrade the communication quality. The same is applied to an interference of the base station 501-1 with the D2D communication of the other respective terminals when the respective D2D terminals not shown perform the D2D communication. On the other hand, when the base station 501-1 selects the terminal 502-1 as the terminal that performs the D2D communication, a transmission power necessary for the base station 501-1 to perform the D2D communication with the terminal 502-1 may be smaller than a transmission power necessary to perform the D2D communication with the terminal 502-2. In other words, the transmission power necessary for the D2D unit of the base station 501-1 to perform the D2D communication with the terminal 502-1 may be smaller than the transmission power of the signal transmitted by the cellular unit of the base station 501-1 with the use of the downlink radio resources. As a result, an interference power of the D2D transmission in the base station 501-1 with the base station 501-2 can be reduced. Likewise, an interference with other D2D terminals not shown can be reduced.

This can be realized, for example, as follows. The terminal 502-1 or 502-2 measures a reception power (called “RSRP (reference signal received power)”) of a reference signal transmitted by the base station 501-1 or another base station (for example, base station 501-2) connected to the subject terminal 502-1 or 502-2, in order to be used for hand-over. If given conditions are satisfied periodically according to the setting from the base station 501-1, the reception power of the respective base stations that have measured the reception powers is informed the base station 501-1. In this case, it is conceivable that the reception power of the reference signal of the base station 501-1 in the terminal 502-1 is larger than the reception power of the reference signal of the base station 501-1 in the terminal 502-2. For that reason, if the terminal 502-1 and the terminal 502-2 each have the D2D capability, the base station 501-1 can select the terminal 502-1 as the terminal that performs the D2D communication. Alternatively, the base station 501-1 may select the terminal that performs the D2D communication on the basis of another standard. For example, the base station 501-1 may select a terminal that is large in ratio of the reception power of the base station 501-1 and the reception power of the adjacent base station 501-2 as the terminal that performs the D2D communication.

In this way, the base station selects the terminal to be selected for performing the D2D communication so as to reduce an interference with another base station or terminal. As a result, the communication quality of the overall system when the base station performs the D2D communication with the use of the uplink resources can be prevented from being degraded. This can be achieved by the radio communication system (that is, the use of the D2D communication) of this embodiment. That is, the D2D transmission signal transmitted by the base station with the use of the uplink resources has only to be received by only a specific terminal, and the other terminals have no need to receive the D2D transmission signal. For that reason, the transmission power can be regulated according to the specific terminal.

On the other hand, in the related art radio communication system that changes a part or all of the uplink resources in the base station to the downlink resources, the downlink signal in the changed downlink resources is received by all of the terminals within the communication area of the base station. For that reason, the transmission power cannot be reduced for the specific terminal. In particular, the transmission power of the base station for the signal for broadcasting the reference signal, the synchronization signal, or the system information need to be equal to all of the terminals.

What is claimed is:

1. A base station, comprising:
a cellular unit that performs cellular communication with a terminal;
a D2D unit that performs communication with the terminal through a device-to-device communication system; and
a control unit that determines a usage status of downlink radio resources and a usage status of uplink radio resources,
wherein if the downlink radio resources get tight, and the uplink radio resources are redundant as a result of the determination, the D2D unit conducts transmission and reception with the terminal with the use of the uplink radio resources.

2. The base station according to claim 1,
wherein the control unit collects from the terminals information indicative of whether the terminal can perform communication through the device-to-device communication system, or not, and
wherein the control unit select one or a plurality of the terminals with which the D2D unit conducts the transmission and reception with the use of the uplink radio resources, from the terminals that can perform the communication through the device-to-device communication system.

3. The base station according to claim 2,
wherein the control unit collects measurement results of a reception power of a reference signal transmitted by the base station from the terminals, and
wherein if a plurality of the terminals that can perform communication through the device-to-device communication system is present, the control unit selects the terminals, the reception power of the reference signal of which is larger, as the terminals with which the D2D unit conducts transmission and reception through the uplink radio resources.

4. The base station according to claim 3,
wherein a transmission power of a signal transmitted by the D2D unit with the use of the uplink radio resources is smaller than a transmission power of a signal transmitted by the cellular unit with the use of the downlink radio resources.

5. The base station according to claim 1,
wherein if the control unit determines that the uplink radio resources get tight, or if the control unit determines that the downlink radio resources are redundant, the D2D unit terminates transmission and reception with the terminal with the use of the uplink radio resources.

6. The base station according to claim 1,
wherein the control unit determines whether the downlink radio resources and the uplink radio resources get tight, or are redundant, on the basis of a usage rate of the downlink radio resources and a usage rate of the uplink radio resources.

7. The base station according to claim 1,
wherein the cellular unit does not schedule an uplink data communication of the terminal that communicates with the cellular unit in time resources or frequency resources in which the D2D unit transmits a signal to the terminal with the use of the uplink radio resources.

8. The base station according to claim 1,
wherein when the D2D unit transmits a signal to the terminal with the use of the uplink radio resources, the D2D unit transmits the signal to the terminal without overlapping with the frequency resources used by the terminal for transmission of ACK or NACK to downlink data or downlink radio channel state information, and with the use of uplink frequency resources in the vicinity of a center of a frequency bandwidth.

9. The base station according to claim 1,
wherein when the base station performs communication with the use of a plurality of frequency carriers, a frequency carrier in which the D2D unit does not transmit or receive with respect to the terminal with the use of the uplink radio resources is configured as a main carrier or a primary cell of the terminal, and a frequency carrier in which the D2D unit transmits or receives with respect to the terminal with the use of the uplink radio resources is configured as a sub-carrier or a secondary cell of the terminal.

10. The base station according to claim 1,
wherein when the base station performs communication with the use of a plurality of frequency carriers, and the D2D unit transmits a signal to the terminal with the use of a first frequency carrier, the base station schedules uplink data transmission in a second frequency carrier to the terminal.

11. A base station, comprising:
a cellular unit that performs cellular communication with a terminal;
a D2D unit that performs communication with the terminals through a device-to-device communication system; and
a control unit that determines a usage status of uplink radio resources,
wherein if the uplink radio resources are redundant as a result of the determination, the D2D unit conducts transmission and reception with another base station with the use of the uplink radio resources.

12. The base station according to claim 11,
wherein the control unit collects information indicative of whether the terminal can perform communication through the device-to-device communication system, or not, from the terminal, and
wherein if the terminal that can perform communication through the device-to-device communication system is not present, the D2D unit conducts transmission and reception with the another base station with the use of the uplink radio resources.

13. The base station according to claim 11,
wherein the D2D unit transmits and receives control information transmitted and received by the another base station through a mobility management equipment, or control information transmitted and received through an interface between the base station and the another base station, with respect to the another base station with the use of the uplink radio resources.

14. The base station according to claim 11,
wherein the D2D unit transmits and receives data, control information, or both of the data and the control information of a terminal connected to the another base station, which is received from a core network, with respect to the another base station with the use of the uplink radio resources.

15. A radio communication method in a radio communication system having a terminal and a base station,
wherein the base station performs cellular communication with the terminal, and
wherein if downlink radio resources get tight, and uplink radio resources are redundant, the base station conducts transmission and reception with the terminal with the use of the uplink radio resources.
